(19) United States
(12) Patent Application Publication
(10) Pub. No.: US 2011/0293869 A1
(43) Pub. Date: Dec. 1, 2011

(54) HIGH MELT FLOW RANDOM POLYPROPYLENE COPOLYMER

(75) Inventors: Elina Myhre, Porsgrunn (NO); Pirjo Jääskeläinen, Porvoo (FI)

(73) Assignee: BOREALIS TECHNOLOGY OY, Porvoo (FI)

(21) Appl. No.: 12/305,692

(22) PCT Filed: Jun. 29, 2007
(86) PCT No.: PCT/EP07/05810

§ 371 Date: Aug. 8, 2011

(30) Foreign Application Priority Data
Jun. 30, 2006 (EP) 06013615.7

(51) Int. Cl. C08L 23/12; B32B 27/32; B32B 1/02; C08F 110/06; C08F 210/00

(52) U.S. Cl. 428/36.92; 526/351; 526/348; 524/582

(57) ABSTRACT

The present invention provides polymer compositions, comprising a random propylene copolymer having an MFR₂ value of 70 or more (g/10 min), which is in particular suitable for preparing thin-walled packaging products by injection molding.

The present invention concerns a polymer composition, comprising a propylene polymer with a high melt flow rate, providing a good balance of usually conflicting properties, such as transparency, stiffness and flowability. The present invention also concerns a process for preparing such a polymer composition and the use of the polymer composition for preparing molded products.

### PRIOR ART

Propylene polymers are vastly used for packaging applications, including films and foils as well as molded products, in particular thin-walled rigid containers. Typical areas where such propylene polymer packaging materials are employed are the food area, in particular consumer products, such as convenient food, confectionary and bakery, frozen food, ice cream, dairy and yellow fat products, as well as everyday commodities, fruits, spices, seafood and pet food, as well as other areas, such as in the chemical industry or household product and cosmetic industry, where propylene polymer packaging materials are employed for packaging chemicals, paints, adhesives, household chemicals as well as cosmetics.

In the packaging field, high requirements are imposed on various properties of the packaging material, properties which sometimes are conflicting. It is of course necessary that the packaging materials provide a sufficient mechanical integrity, such as stiffness, impact properties etc. in order to enable a safe packaging of the various products. At the same time, the appearance of packaged product is becoming more and more important, so that also optical properties, including stable color, low tendency towards discoloration and transparency are becoming more important. Furthermore, most of the packaging materials mentioned above are mass products so that also a high production speed for such products is required, which increases the demand for materials having a sufficient flowability for the various manufacturing methods, including blow molding, injection molding, casting and foaming processes as well as extrusion and thermoforming processes. In this connection, it furthermore has to be taken into account that, in particular, optical properties and mechanical properties are often conflicting, i.e. the increase of one of those properties most often leads to the decrease of the other one.

Accordingly, there is a high demand for packaging materials, in particular propylene polymers, which provide a good balance of properties, such as flowability, mechanical properties and optical properties.

EP 1544219 A1 discloses impact strength polypropylenes which are degraded with a linear dialkyl peroxide at degradation rates of greater than 5. The polypropylene subjected to such a degradation is preferably a heterophasic copolymer with ethylene contents of up to 20 wt %. The obtained products are described as being suitable for thin-walled packaging with good mechanical properties, requiring no elastomeric modifiers.

WO 02/12384 A1 describes the degradation of propylene polymers with a specific peroxide, namely di-t-amylperoxide. The advantage of using this peroxide according to the disclosure in WO 02/12384 A1 is the possibility to obtain products with acceptable odor profiles.

EP 1186618 A1 discloses controlled rheology propylene heterophasic copolymers, i.e. compositions comprising a polypropylene matrix phase and a dispersed phase of an elastomeric copolymer. EP 1186618 A1 in this respect discloses that the heterophasic composition typically consists of a polypropylene homopolymer, a rubbery ethylene propylene bi-polymer and a crystalline ethylene rich ethylene propylene bi-polymer, wherein the ethylene containing copolymers conventionally have to be considered as block copolymers.

EP 0985686 A2 discloses a polypropylene material, suitable in particular for spinning applications. The examples of this document disclose propylene homopolymers suitable for fiber applications.

U.S. Pat. No. 5,246,779 discloses propylene polymer powders having reduced fines, obtained by a process involving dispersing a molten propylene homopolymer or copolymer in the presence of a nonionic surfactant, cooling the dispersion and recovering the powder.

U.S. Pat. No. 3,607,987 discloses a coating composition comprising a blend of a copolymer containing a major amount of propylene and a low density homopolymer of ethylene.

All these prior art materials, however, do not provide a required balance of properties, in particular mechanical and optical properties (impact properties and haze) as well as a suitable processibility, exemplified by flowability, enabling the use of the materials for molded products in packaging applications, in particular for thin walled rigid containers.

The term “random copolymer” as employed in the present application defines a copolymer wherein the individual types of monomers are polymerized together to form a polymer wherein the individual repeating units are present in a random or statistical distribution in the polymer chain.

### OBJECT OF THE PRESENT INVENTION

In view of the drawbacks associated with the prior art products as discussed above, it is the object of the present invention to provide a propylene polymer, in particular suitable for packaging applications, providing a satisfactory balance of properties, in particular mechanical and optical properties, as well as properties concerning the processibility, such as flowability.

### BRIEF DESCRIPTION OF THE PRESENT INVENTION

The present invention solves the above object by providing a polymer composition as defined in claims 1 and 2. The present invention furthermore provides a polymer composition as defined in claim 10. Preferred embodiments are described in the respective sub-claims as well as in the following description. The present invention furthermore provides a process for preparing a polymer composition, molded products, prepared from the polymer composition in accordance with the present invention and the use of a polymer composition in accordance with the present invention for preparing molded products as defined in claims 12, 13 and 17, respectively. Preferred embodiments are again defined in the sub-claims as well as in the following description.

### DETAILED DESCRIPTION OF THE INVENTION

As identified in claim 1, the present invention provides a polymer composition, comprising a propylene polymer having an MFR₂ value of 70 or more (g/10 min), wherein the propylene polymer is a random copolymer. The MFR₂ value as defined herein is to be determined in accordance with the method as explained in the respective passage of the present application.

Preferably, the MFR₂ value of the propylene polymer in accordance with the present invention is from 70 to 150, more preferably from 75 to 130 and, in particular, from 80 to 120 (g/10 min). Melt flow rates within the range as provided by the propylene polymer in accordance with the present invention enable the preparation of thin-walled articles with complex geometries with high accuracy and fully satisfactory production speeds, since the polymer composition in accordance with the present invention provides a very good flowability in the melt phase. This already demonstrates a clear advantage of the polymer composition in accordance with the present invention over the prior art materials.

As furthermore defined in claim 1, the propylene polymer is a random copolymer, wherein the comonomer preferably is at least one member selected from the group of ethylene and C₄-C₂₀-α-olefins, preferably ethylene and C₄-C₁₀-α-olefins, in particular preferably ethylene. The propylene polymer in accordance with the present invention typically comprises one comonomer only, but the present invention also envisages to use two or more comonomers in mixture.

The comonomer content in the propylene polymer in accordance with the present invention typically amounts to from 1 to 7 wt %, more preferably from 2 to 7 wt % and in particular from 2 to 6 wt %.

A particular preferred propylene polymer to be employed in accordance with the present invention is a random propylene copolymer comprising ethylene as only comonomer, in amounts as illustrated above and in embodiments also from 2.5 to 4 wt %, such as 2.5 or 3.5 wt %.

Surprisingly, it has been found by the inventors of the present application that a propylene polymer as defined in claim 1 not only provides the desired processibility, enabling, as outlined above, the preparation of thin-walled articles with complex in geometries, but also provides a, compared with the prior art, superior balance of mechanical and optical properties, such as, in particular, stiffness, impact properties and transparency. This improved balance of properties is illustrated further in the examples provided further below.

As indicated above, the propylene polymer in accordance with the present invention is a random copolymer. In accordance with the present invention, it is envisaged to use unimodal as well as multimodal, in particular bimodal propylene polymers. Bimodal propylene polymers envisaged by the present invention may either be bimodal with respect to the molecular weight distribution, as for example expressed by the melt flow rate and/or bimodal with respect to the comonomer content. Preferably, the propylene polymer in accordance with the present invention is not a heterophasic propylene polymer.

The polymer composition in accordance with the present invention may also comprise additional components, such as usual additives and other polymeric components, which may be selected depending from the desired type of end use. The polymer composition in accordance with the present invention in particular may comprise a nucleating agent, which may be included into the polymer composition in an amount of from 400 to 3000 ppm (by weight) relative to the amount of propylene polymer.

Typical examples of nucleating agents are phosphate derived nucleating agents, sorbitol derived nucleating agents, metal salts of aromatic or aliphatic carboxylic acids, inorganic nucleating agents, in particular talc, as well as polymeric nucleating agent.

Preferred sorbitol derived nucleating agents are nucleating agents such as those sold under the tradename Millad, e.g. Millad 3988 from Milliken.

Preferred polymeric nucleating agents are polymers obtainable by polymerizing a vinyl compound having the formula CH₂CHCHR₁R₂, wherein R₁ and R₂, together with the carbon atom they are attached to, form an optionally substituted, saturated or unsaturated or aromatic ring or a fused ring system, wherein the ring of the fused ring moiety contains 4 to 20 carbon atoms, preferably a 5 to 12-membered saturated or unsaturated or aromatic ring or a fused ring system, or independently represent a linear or branched C₄-C₃₀ alkane, C₄-C₃₀ alkane, C₄-C₂₀ cycloalkane or C₄-C₂₀ aromatic ring. Most preferably, the polymeric nucleating agent is a vinyl cyclohexane polymer.

Nucleating agents as illustrated above may be incorporated into the polymer composition either by post polymerization processes, including admixing the nucleating agent using the master batch technology, or the nucleating agent may already be present during the preparation, i.e. polymerization of the propylene polymer, using, for example, suitably adapted polymerization catalysts, typically catalysts which have been subjected to a prepolymerization in the presence, for example, of a vinyl compound as defined above. Using this technology, suitable amounts of polymeric nucleating agent in particular can be incorporated into the propylene polymer, with a very even and uniform distribution. Reference in this respect can be made to the disclosure in WO 99/24478, WO 99/224479 and WO 00/68315.

The present invention also provides a polymer composition comprising a propylene polymer,

wherein the propylene polymer displays a flow property, as measured in a spiral flow test described further below, of more than 26 cm at 600 bar, more than 35 at cm 1000 bar, more 45 cm at 1400 bar. Preferred embodiments of this polymer composition are defined in the sub-claims and described in the present specification in connection with the polymer composition in accordance with claim 1. The polymer composition of this embodiment of the present invention provides the same improvements over the prior art materials as outlined above, in particular the improved balance of properties concerning flow properties (production speed and production accuracy) as well as optical and mechanical properties.

More preferably, the propylene polymer in accordance with this embodiment displays a flow properties, measured as indicated above, of 29 cm or more at 600 bar, of 40 cm or more at 1000 bar and of 49 cm or more at 1400 bar.

The embodiment of the present invention as defined in claim 2 and as further illustrated above also provides fully satisfactory haze values of lower than 30%, preferably lower than 20% and more preferably lower than 15%, as also illustrated below. The materials according to this embodiment preferably provide a tensile modulus of more than 900, such as from more than 900 to 1600, or up to 1400 (MPa), preferably in combination with a haze value of lower than 30%, more preferably lower than 20% and most preferably lower than 15%. The material in accordance with this embodiment preferably also is a random copolymer as defined herein.

Typically, the polymer composition in accordance with the present invention as defined in claim 1 provides molded articles having very satisfactory optical properties, such as illustrated by haze values (determined with molded test specimens having a thickness of 1 mm, prepared and tested as described further below) of less than 30%, preferably less than 20% and more preferably less than 15%. The polymer composition in accordance with the present invention typically provides further satisfactory mechanical properties, such as values for tensile modulus (determined as described further below) of from 250 to 1600, preferably 250 to 1400 and more preferably from 350 to 1400 (MPa), drop height more than 0.8 m, preferably more than 0.9-m, most preferably more than 1 m and top load more than 190N, more preferably more than 200 N, most preferably more than 220N. The propylene polymer in accordance with the present invention typically has a melting temperature (Tm; ° C.; determined as described below) of from 130 to 160, preferably 130 to 155 and more preferably from 135 to 155. Accordingly, the propylene polymer enables a satisfactory processability, requiring in particular temperatures for the preparation of molded articles which are not detrimental to the polymer composition or to any of the usual additives employed therewith.

Another measure for defining mechanical properties are impact values, in particular charpy notched impact (measured at room temperature, 23° C. if not otherwise stated) which may be 4 kJ/m² or more for the polymer compositions in accordance with the present invention, and in embodiments 4.5 or more or even 5 or more.

As already identified above, the polymer composition in accordance with the present invention is, in particular, suitable for preparing molded articles, in particular by injection molding processes, wherein the molded articles are, in particular, thin-walled packaging products which may have a complex geometry. With the thin-walled articles the present application intends to describe articles comprising at least a part having a wall thickness of less than 1.5 mm, or having a ratio of flow length to wall thickness of larger than 200.

As defined in claim 12, the polymer composition in accordance with the present invention, in particular, can be obtained by subjecting a propylene polymer to visbreaking, preferably at visbreaking ratios (visbreaking ratio: final MFR₂ divided by initial MFR₂) of from 6.5 to 15, wherein the propylene polymer to be employed in accordance with the present invention is a random copolymer as defined herein. Surprisingly, it has been found that subjecting a propylene polymer as defined herein to visbreaking provides the polymer composition as defined herein, having in particular the highly desirable balance of mechanical properties, optical properties and processing properties, enabling in particular, as outlined above, the preparation of thin-walled packaging articles having complex geometries by injection molding with high accuracy and high production speeds. Contrary to propylene homopolymers, the present invention provides the surprising finding that the desired balance of properties can be obtained when using propylene polymers as defined herein. Propylene homopolymers known from the art clearly show a degradation of the balance of properties when subjecting propylene homopolymers to visbreaking.

Accordingly, the present invention furthermore provides, as already indicated above, a polymer composition obtainable by visbreaking a propylene polymer at a visbreaking ratio of typically from 6.5 to 15, wherein the propylene polymer is a random copolymer, as defined in claim 10.

The visbreaking ratio to be employed in accordance with the present invention more preferably is from 7 to 15, in particular from 10 to 15.

Visbreaking may be carried out in any known manner, but typically the present invention envisages chemical visbreaking using a peroxide visbreaking agent. Typical visbreaking agents are, in particular, peroxide sold under the tradenames Trigonox 101 and Trigonox 301, both available from Akzo. Suitable amounts of peroxide to be employed in accordance with the present invention are in principle known to the skilled person and can easily be calculated on the basis of the amount of propylene polymer to be subjected to visbreaking, the MFR₂ value of the propylene polymer to be subjected to visbreaking and the desired target MFR₂ of the product to be obtained. Typical amounts of peroxide visbreaking agent are, however, from 0.01 to 0.1 wt %, based on the amount of propylene polymer employed.

Typically, visbreaking in accordance with the present invention is carried out in an extruder, so that under the suitable conditions, an increase of melt flow rate is obtained. During visbreaking, higher molar mass chains of the starting product are cleared statistically more frequently than lower molar mass molecules, resulting in an overall decrease of the average molecular weight and an increase in melt flow rate. Suitable visbreaking degrees and visbreaking conditions are illustrated in the examples below.

The propylene polymer to be subjected to visbreaking in accordance with the present invention may be any type of propylene polymer, as long as it is a random copolymer as defined herewith. Preferably, the propylene polymer is not a heterophasic propylene composition. However, the present invention envisages to use unimodal propylene polymers as well as multimodal propylene polymers, which may in particular be bimodal with respect to the molecular weight distribution, expressed for example as melt flow rate and/or comonomer content. The propylene polymers to be employed in accordance with the present invention, as identified above, are random copolymers and the preferred embodiments with respect to type of comonomers and comonomer contents as illustrated above in connection with the description of claim 1 also apply with respect to the description provided here for claims 10 and 12.

As identified above, the propylene polymer to be employed in accordance with the present invention may be bimodal with respect to the comonomer content as well as with respect to the type of comonomer. Furthermore, the present invention also envisages the use of propylene polymers which are bimodal with respect to the molecular weight distribution, which may be expressed with respect to the melt flow rate. In the case of multimodal, in particular bimodal propylene polymers with respect to the molecular weight distribution, the propylene polymer comprises at least a lower molecular weight component (LMVV) and a higher molecular weight component (HMW). The lower molecular weight component has a higher MFR than the higher molecular weight component. The ratio between the MFR₂ value of the LMW and the MFR₂ value of the HMW component is not critical and may be selected from a broad range of, for example, at least 3, more preferably at least 4, more preferably at least 10, and in embodiments also up to 100 or up to 150. The respective amounts of LMW component and HMW component also may be selected in accordance with the desired end application, and the amount of LMW component is typically between 30 to 70 wt %, preferably 40 to 60 wt %, based on the total amount of propylene polymer.

According to a preferred embodiment of the present invention, the propylene polymer to be employed is a reactor made polymer. Reactor made polymers define products which are obtained from a polymerization reaction of olefin monomers, meaning that a reactor made polymer is the polymerization product as obtained from the polymerization step. Such a reactor made polymer accordingly is a different embodiment compared with mechanical blends, wherein a first polymer is produced in the absence of any further polymeric components and then blended mechanically with a second component.

Concerning the polymerization process suitable for preparing propylene polymers to be employed in accordance with the present invention in principle any polymerization methods, including solution, slurry and gas phase polymerizations can be used.

In the following, a preferred process for preparing a random propylene polymer to be employed in the present invention is described.

When the polymer is unimodal with respect to the molecular weight distribution and comonomer distribution, it may be prepared in a single stage process e.g. as slurry or gas phase process in a slurry or gas phase reactor. Preferably, the such unimodal material, however, is produced in a multistage process using at each stage process conditions as illustrated further below.

The random copolymer to be used in accordance with the present invention may be prepared by polymerizing, in a slurry reactor, for example a loop reactor, propylene monomers together with one or more comonomers, in the presence of a polymerization catalyst to produce a part of the random copolymer. This part is then transferred to a subsequent gas phase reactor, wherein in the gas phase reactor propylene monomers are reacted in the presence of suitably selected comonomers in order to produce a further part in the presence of the reaction product of the first step. This reaction sequence provides a reactor blend of parts (i) and (ii) constituting a random copolymer. It is of course possible by the present invention that the first reaction is carried out in a gas phase reactor while the second polymerization reaction is carried out in a slurry reactor, for example a loop reactor. It is furthermore also possible to reverse the order of producing parts (i) and (ii), which has been described above in the order of first producing part (i) and then producing part (ii). The above-discussed process, comprising at least two polymerization steps, is advantageous in view of the fact that it provides easily controllable reaction steps enabling the preparation of a desired reactor blend. The polymerization steps may be adjusted, for example by appropriately selecting monomer feed, comonomer feed, hydrogen feed, temperature and pressure in order to suitably adjust the properties of the polymerization products obtained. It is in particular possible to obtain the preferred multimodality, preferably the bimodality, of the random copolymer, with respect to the ethylene distribution as well as with respect to the molecular weights and MFR₂ values during said multistage polymerization procedures.

Such a process can be carried out using any suitable catalyst for the preparation of propylene monomers, including. Preferably, the process as discussed above is carried out using a Ziegler-Natta catalyst, in particular a high yield Ziegler-Natta catalyst (so-called fourth and fifth generation type to differentiate from low yield, so called second generation Ziegler-Natta catalysts). A suitable Ziegler-Natta catalyst to be employed in accordance with the present invention comprises a catalyst component, a co-catalyst component and at least one electron donor (internal and/or external electron donor, preferably at least one external donor). Preferably, the catalyst component is a Ti—Mg-based catalyst component and typically the co-catalyst is an Al-alkyl based compound. Suitable catalysts are in particular disclosed in U.S. Pat. No. 5,234,879, WO 92/19653, WO 92/19658 and WO 99/33843, incorporated herein by reference.

A suitable Ziegler-Natta catalyst to be employed in accordance with the present invention comprises a catalyst component, a co-catalyst component and at least one electron donor (internal and/or external electron donor, preferably at least one external donor). Preferably, the catalyst component is a Ti—Mg based catalyst component and typically the co-catalyst is an Al-alkyl based compound. Suitable catalysts are in particular disclosed in U.S. Pat. No. 5,234,879, WO 92/19653, WO 92/19658 and WO 99/33843, incorporated herein by reference.

Preferred external donors are the known silane-based donors, such as dicyclopentyl dimethoxy silane or cyclohexyl methyldimethoxy silane.

One embodiment of a process as discussed above is a loop-gas phase process, such as developed by Borealis, known as Borstar® technology, described for example in EP 0887379 A1 and WO 92/12182, incorporated herein by reference.

With respect to the above-mentioned preferred slurry-gas phase process, the following general information can be provided with respect to the process conditions.

Temperature of from 40° C. to 110° C., preferably between 60° C. and 100° C., in particular between 80° C. and 90° C., with a pressure in the range of from 20 to 80 bar, preferably 30 to 60 bar, with the option of adding hydrogen in order to control the molecular weight. The reaction product of the slurry polymerization, which preferably is carried out in a loop reactor, is then transferred to the subsequent gas phase reactor, wherein the temperature preferably is within the range of from 50° C. to 130° C., more preferably 80° C. to 100° C., at a pressure in the range of from 5 to 50 bar, preferably 15 to 35 bar, again with the option of adding hydrogen in order to control the molecular weight.

The residence time can vary in the reactor zones identified above. In embodiments, the residence time in the slurry reaction, for example the loop reactor, is in the range of from 0.5 to 5 hours, for example 0.5 to 2 hours, while the residence time in the gas phase reactor generally will be from 1 to 8 hours.

The properties of the random copolymer produced with the above-outlined process may be adjusted and controlled with the process conditions as known to the skilled person, for example by one or more of the following process parameters: temperature, hydrogen feed, comonomer feed, propylene feed, catalyst, type and amount of external donor, split between two or more components of a multimodal polymer.

As indicated in the claims, the present invention also provides molded articles, prepared from the polymer compositions in accordance with the present invention, preferably obtained by the process in accordance with the present invention. Examples of typical molded articles are rigid containers for packaging purposes. Preferably, these molded articles are produced by injection molding, in particular since the polymer compositions in accordance with the present invention enable the preparation of such molded products with high accuracy and high production speeds due to the improved flow properties.

The molded articles obtained in accordance with the present invention, in particular thin-walled articles with complex geometries, provide highly satisfactory mechanical properties, such as drop height and top load illustrated and determined in the following examples in accordance with the methods as described herein. Furthermore, the molded articles do provide highly satisfactory visual appearance, such as transparency and low discoloration and reduced tendency towards discoloration.

### Definitions and Determination Methods Used in the Claims, Above Description, Below Examples

MFR₂, unless otherwise specified, is measured MFR₂ in accordance with ISO 1133 (230° C., 2.16 kg load)

Comonomer content (wt %) is determined in a known manner based on FTIR, calibrated with C13NMR.

Melting temperature, crystallization temperature and degree of crystallinity are measure with a Mettlas TA820 differential scanning calorimetry device (DSC) on 3±0.5 mg samples. Crystallization and melting temperatures are obtained during 10° C./min cooling and heating scans between 30 and 225° C. Melting and crystallization temperatures were taken as peaks of endotherms and exotherms. The degree of crystallinity is calculated by comparison with the heat of fusion of a perfectly crystalline polypropylene, i.e. 209 J/g.

Charpy notched impact is measured according to ISO 179 (room temperature, if not otherwise mentioned) using injection molded test specimen as described in ENISO 1873-2 (80×10×4 mm).

Tensile strength, including tensile stress at yield and strain at yield, is measured according to ISO 572-2 (cross head speed 50 mm/min). Tensile modulus is measured according to ISO 572-2 (cross head speed 1 mm/min).

Haze and transparency are determined from 1 mm (or 2 mm when specified) injection molded plaque samples according to ASTMD 1003.

### Top Load

The compression test used to measure the rigidity of injection molded 850 ml cups followed the method of standard test ASTM 2659-95 on a Zwich tensile machine operated at a velocity of 10 mm/min.

Dimensions of the cup: height 100 mm, Diameter top 115 mm, Diameter bottom 95 mm, bottom wall thickness 0.44 mm, wall thickness walls 0.38 mm.

### Drop Height Test

was performed on cups at 23° C. according to ASTM-D 2463-95. The height at which 50% of the cups break in a brittle way, F50, was recorded

### Spiral Flow

Spiral Test is carried out using an Engel ES330/65 cc90 injection molding apparatus with a spiral mould and pressure of 600, 1000 or 1400 bar

screw diameter: 35 mm

max. piston displacement: 150 cm³

spec. injection pressure: 600, 1000, or 1400 bar

tool form: oval form; provided by Axxicon; thickness 2 mm, 1 mm or 3 mm, breadth: 5 mm

temperature in pre-chamber and die: 230° C.

temperature in zone 2/zone 3/zone 4/zone 5: 230° C./230° C./225° C./200° C.

injection cycle: injection time including holding: 15 s

cooling time: 15 s

injection pressure: Follows from the predetermined length of the testing material.

dwell pressure=injection pressure

screw speed: 30 rpm

system pressure: 160 bar

metering path: Metering stroke should be set so the screw stops 20 mm before final position by end of the holding pressure.

tool temperature: 40° C.

The spiral flow length can be determined immediately after the injection operation.

The following examples illustrate the present invention further.

### EXAMPLES

Propylene polymers were subjected to visbreaking using a peroxide visbreaking agent in an extruder, providing polymer compositions in accordance with the present invention (Examples 1 to 4) as well as one comparative example (Reference) (MFR₂ value lower than required by the present invention). The obtained polymer compositions were subjected to various tests, the results of which are summarized in Tables 1 and 2. The examples as provided clearly demonstrate that the compositions in accordance with the present invention show a better overall balance of property, compared with the reference examples, using a commercially available random polypropylene.

TABLE 1

| | | Example 1 | Example 2 | Example 3 | Example 4 | Example 5 | Reference 1 | Reference 2 |
|---|---|---|---|---|---|---|---|---|
| MFR₂ before visbreaking | g/10 min | 10 | 8 | 10 | 8 | 7.5 | 13 | 9 |
| MFR₂ | g/10 min | 70 | 70 | 100 | 100 | 92 | 45 | 45 |
| Visbreaking degree | | 7 | 8.8 | 10 | 12.5 | 12 | 3.5 | 5 |
| Ethylene content | % | 3.5 | 2.7 | 3.5 | 2.7 | 2.5 | 3.5 | 3.5 |
| Tm of PP | ° C. | 149.4 | 152.4 | 149 | | 147.6 | 147.4 | 149.4 |
| Crystallinity | % | 41.33 | 44.9 | 42.6 | | 39 | 41.8 | 35.6 |
| Tcr of PP | ° C. | 119.6 | 121 | 119.6 | | 119.8 | 116.6 | 120 |
| Tensile modulus | MPa | 950 | 1210 | 910 | 1200 | 27.8 | 1050 | 26.7 |
| Tensile stress at yield | MPa | 26.2 | 30.5 | 25.8 | 30 | 12.5 | 28.9 | 12.2 |
| Tensile strain at yield | % | 12.3 | 11.6 | 12.6 | 11 | 1030 | 12.3 | 960 |
| Charpy, notched, RT | kJ/m² | 5 | 5.2 | 4.8 | 4.9 | 4.7 | 5.5 | 5.4 |
| Haze 2 mm | % | 50 | 28 | 52 | 59 | 27 | 23 | 49 |
| Haze 1 mm | | 28 | 13 | 29 | | 13 | 11 | 26 |
| Drop height 23° C., 850 ml | m | 1 | 1.2 | 1.1 | 1.5 | 1.5 | <0.8 | <0.8 |
| Top load | N | 200 | 250 | 195 | 230 | | 220 | 215 |
| Spiral flow test 600 bar | cm | | 29 | | | | 26 | |
| Spiral flow test 1000 bar | cm | | 40 | | | | 35 | |
| Spiral flow test 1400 bar | cm | | 49 | | | | 45 | |

The propylene polymers were prepared as summarized in Table 2 (see also WO 99/24478, Example 8), using a multistage polymerization process comprising a prepolymerization, a polymerization in a loop reactor (slurry polymerization), followed by a final polymerization in a gas phase reactor. The obtained polymer products were visbroken by using Trigonox 101 from Akzo Nobel and compounded with the following additives; Irganox B215 (1500 ppm), DHT-4A (400 ppm) for example 1, 3 and in addition Gel All E200 (1800 ppm), Gel All MD-LM30 and Millad 3988 (1700 ppm) for example 2, 4, 5 respectively. Reference 1 also contained Millad 2988 (1700 ppm).

The results as obtained are summarized in Table 1 above.

TABLE 2

| | Ex. 1 and Ex. 3 | Ex. 5 | Ex. 2 and Ex. 4 |
|---|---|---|---|
| Donor type | Dicyclopentyl | Dicyclopentyl | Dicyclopentyl |
| | dimethoxy | dimethoxy | dimethoxy |
| | silane | silane | silane |
| Catalyst feed (g/h) | 1.3 | 0.9 | 1 |
| Cocatalyst feed | 73 | 150 | 150 |
| (g/t propylene) | | | |
| Al/Ti ratio (mol/mol) | 200 | 376 | 250 |
| Al/donor ratio | 10 | 10 | 10 |
| (mol/mol) | | | |
| Prepol | | | |
| Temperature (° C.) | 30.0 | 30.0 | 30.0 |
| Loop | | | |
| Temperature (° C.) | 80.0 | 70.0 | 70.0 |
| Split % | 63 | 41 | 50 |
| MFR2 (g/10 min) | 11.3 | 8.8 | 8.0 |
| XS (%) | 2.2 | 4.8 | 6 |
| C2 content (%) | 2.1 | 1.9 | 2.7 |
| GPR | | | |
| Temperature (° C.) | 85 | 80 | 80 |
| Split % | 37 | 59 | 50 |
| MFR2 (g/10 min) | 9.4 | 7.6 | 8 |
| XS (%) | 4.2 | 4.4 | 5 |
| Ethylene content (%) | 3.1 | 2.5 | 2.7 |

The catalysts employed were as follows:

Examples 1 and 3 as well as reference 2: WO 00/68315, example 1

Examples 2 and 4: U.S. Pat. No. 5,234,879

Example 5: WO 04/29112, Example 8, but with diethylaluminium chloride used instead of triethyl aluminium.

The examples in accordance with the present invention provide an improved balance of mechanical and optical properties associated with very good flow properties, so that the polymer compositions are suitable for the desired applications as identified in the present application.

1. A polymer composition comprising a propylene polymer having an MFR₂ value of 70 or more (grams/10 minutes), wherein the propylene polymer is a random copolymer.

2. A polymer composition comprising a propylene polymer, wherein the propylene polymer displays a flow property of more than 26 cm at 600 bar, more than 35 cm at 1000 bar and more than 45 cm at 1400 bar, in a spiral flow test.

3. The polymer composition in accordance with claim 2, wherein the propylene polymer has an MFR₂ value of 70 or more (g/10 min) and is a random copolymer.

4. The polymer composition in accordance with claim 1, wherein the propylene polymer has an MFR₂ value of from 70 to 150 (grams/10 minutes).

5. The polymer composition in accordance with claim 1, wherein the propylene polymer is a propylene copolymer comprising from 1 to 7 wt % of a comonomer.

6. The polymer composition in accordance with claim 5, wherein the comonomer is at least one member selected from the group of ethylene and C₄-C₁₀-α-olefins.

7. The polymer composition in accordance with claim 5, wherein the comonomer is present in an amount ranging from content amounts to 2 to 7 wt %.

8. The polymer composition in accordance with claim 5, wherein the comonomer is ethylene.

9. The polymer composition in accordance with claim 1, further comprising nucleating agent.

10. A polymer composition obtainable by visbreaking a propylene polymer at a visbreaking ratio of 6.5 to 15, wherein the propylene polymer is a random copolymer.

11. The polymer composition in accordance with claim 10, where the visbreaking ratio is from 7 to 15.

12. A process for preparing a polymer composition in accordance with claim 1, comprising subjecting a propylene polymer to visbreaking at a visbreaking ratio of from 6.5 to 15, wherein the propylene polymer is a random copolymer.

13. A molded product comprising a polymer composition in accordance with claim 1.

14. A molded product in accordance with claim 13, wherein the product is selected from a container and a packaging material.

15. A molded product in accordance with claim 13, having a drop height of more than 0.8 m when tested according to ASTM-D-2463-95.

16. A molded product in accordance with claim 13, having a top load of more than 190 N and a haze of lower than 30% when measured with 1 mm injection molded plaques according to ASTM1003.

17. (canceled)
